(19) United States
(12) Patent Application Publication
(10) Pub. No.: US 2017/0123440 A1
(43) Pub. Date: May 4, 2017

(54) CROWD COMFORTABLE SETTINGS

(71) Applicant: Honeywell International Inc., Morristown, NJ (US)

(72) Inventors: Purnaprajna R. Mangsuli, Bangalore (IN); Mahesh Kumar Gellaboina, Kurnool (IN); Thirumaran Ekambaram, Bangalore (IN); Joseph C. Surber, Golden Valley, MN (US)

(21) Appl. No.: 14/926,881

(22) Filed: Oct. 29, 2015

(51) Int. Cl. G05D 23/19; F24F 11/00

(52) U.S. Cl. CPC G05D 23/193; F24F 11/0012; F24F 11/0015; F24F 11/0034; F24F 11/006; F24F 2011/0013; F24F 2011/0016; F24F 2011/0035; F24F 2011/0046; F24F 2011/0047; F24F 2011/0057; F24F 2011/0061

(57) ABSTRACT

Methods, devices, and systems for crowd comfortable settings are described herein. One device includes a memory, and a processor configured to execute executable instructions stored in the memory to receive a number of weighted occupant preferences of a building space, receive a number of internal variables of the building space and a number of external variables of the building space, determine whether each weighted occupant preference is feasible, and modify a setting for the number of internal variables of the building space based on whether the number of feasible occupant preferences is greater than a threshold number.

### TECHNICAL FIELD

The present disclosure relates to methods, devices, and systems for crowd comfortable settings.

### BACKGROUND

A building management system (BMS) can face two common challenges: maintaining the comfort of occupants and minimizing energy consumption. In some instances, occupants of a building or a certain space within a building may agree to a certain comfort level of the building and/or building space. However, in instances where there may be disagreement among building occupants, it can be challenging to minimize energy consumption without affecting the comfort of the building occupants.

Past approaches to these challenges can suffer from various drawbacks. For example, one approach can include single user control. Single user control can include using a single thermostat for a building and/or building space. The thermostat can be controlled by a single person (e.g., a supervisor and/or BMS operator), who may only consider his or her own comfort preferences. As a result, single user control may leave some occupants of the building and/or building space unhappy, as their comfort preferences may not have been considered.

As a further example, a different approach can include crowd sourced set-point control utilizing a voting system to determine a setting of a building and/or building space, where occupants can submit a “vote” for the comfort level they would like the building and/or building space set at. However, a voting system can suffer from “vote bullying”, where a majority of occupants can overwhelm the voting system to determine a setting for the building and/or building space that may leave a corresponding minority of occupants unhappy.

### BRIEF DESCRIPTION OF THE DRAWINGS

FIG. 1 is a schematic block diagram of a controller for crowd comfortable settings, in accordance with one or more embodiments of the present disclosure.

FIG. 2 illustrates a system for crowd comfortable settings, in accordance with one or more embodiments of the present disclosure.

FIG. 3 is a schematic block diagram of a controller for crowd comfortable settings, in accordance with one or more embodiments of the present disclosure.

FIG. 4 is a flow chart of a method for crowd comfortable settings, in accordance with one or more embodiments of the present disclosure.

### DETAILED DESCRIPTION

Methods, devices, and systems for crowd comfortable settings are described herein. For example, one or more embodiments include a memory, and a processor configured to execute executable instructions stored in the memory to receive a number of weighted occupant preferences of a building space, receive a number of internal variables of the building space and a number of external variables of the building space, determine whether each weighted occupant preference is feasible, and modify a setting for the number of internal variables of the building space based on whether the number of feasible occupant preferences is greater than a threshold number.

Crowd comfortable settings, in accordance with the present disclosure, can incorporate preferences of occupants of the building and/or building space to be controlled to determine a setting for the building and/or building space. Utilizing occupant preferences to determine settings can maximize the comfort for the most number of occupants of the space to be controlled (e.g., building and/or a building space), while also minimizing energy consumption. Further, comfort preferences of all the occupants of the space to be controlled can be considered in determining the settings of the building and/or building space.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

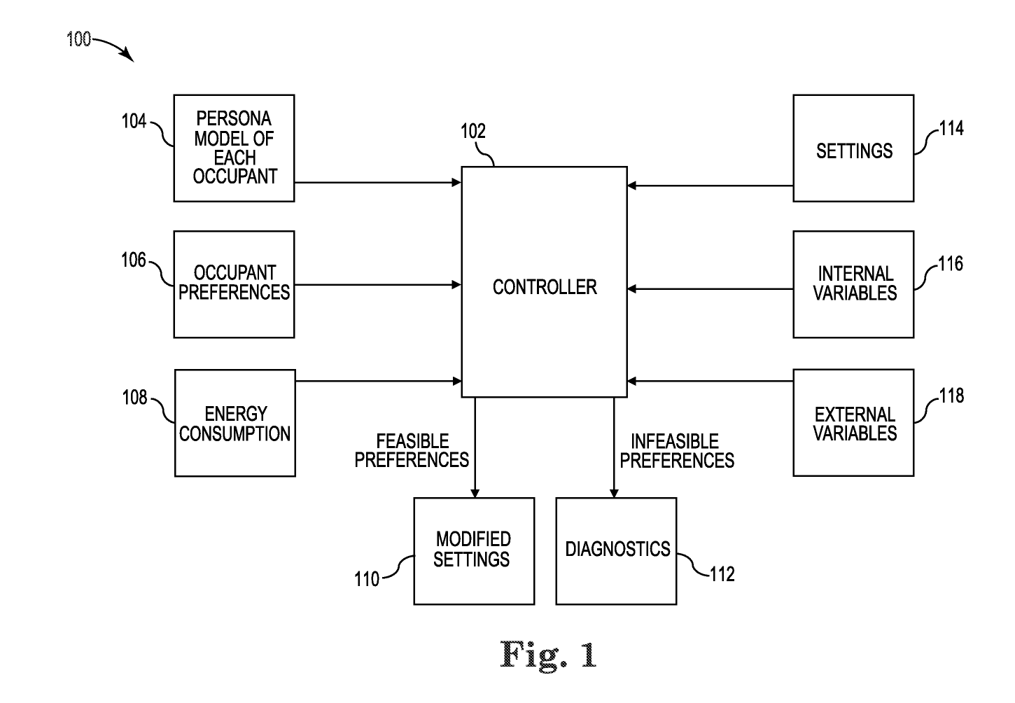

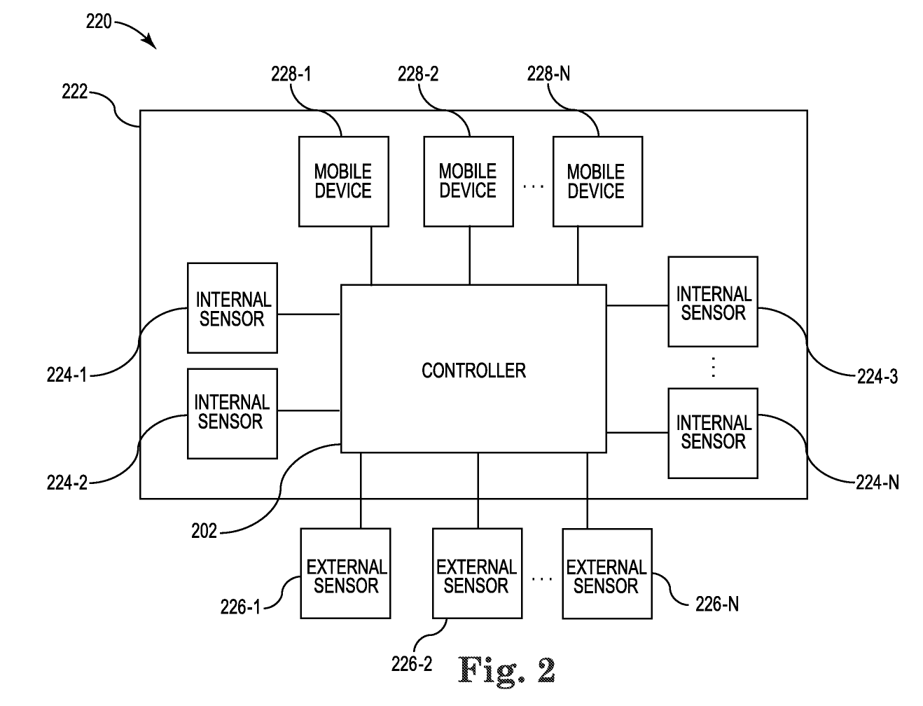

The figures herein follow a numbering convention in which the first digit or digits correspond to the drawing figure number and the remaining digits identify an element or component in the drawing. Similar elements or components between different figures may be identified by the use of similar digits. For example, controller 102 as shown in FIG. 1 can be controller 202, as shown in FIG. 2. Additionally, the designator “N”, as used herein, particularly with respect to reference numerals in the drawings, indicates that a number of the particular feature so designated can be included with a number of embodiments of the present disclosure.

As used herein, “a” or “a number of” something can refer to one or more such things. For example, “a number of mobile devices” can refer to one or more mobile devices.

FIG. 1 is a schematic block diagram of a controller for crowd comfortable settings, in accordance with one or more embodiments of the present disclosure. As shown in FIG. 1, controller 102 can receive a persona model 104 of each occupant, occupant preferences 106, energy consumption 108, settings 114, internal variables 116, and external variables 118. Controller 102 can determine whether each occupant preference 106 is feasible, and modify a setting for a number of internal variables of a building space based on whether a number of feasible occupant preferences is greater than a threshold number, as will be further described herein. As used herein, a setting of an internal variable of a building space can include a set point of the internal variable. For example, modifying a temperature setting can include modifying a temperature set point associated with the building space. As another example, modifying a lighting setting can include modifying a set point of the lighting system associated with the building space.

Controller 102 can receive a number of occupant preferences 106. As used herein, an occupant preference 106 can be a comfort preference of an occupant of a building and/or space within the building. For example, an occupant of a building space can indicate (e.g., by a mobile device, as will be further described herein) whether he or she is comfortable with a number of internal variables (e.g., temperature, lighting, humidity, etc.) of the building space, as will be further described herein. A comfort preference (e.g., a comfort indication or comfort request) of an occupant can be a desire of the occupant to increase general comfort.

The number of occupant preferences 106 can include a climate preference, a lighting preference, and/or an environmental preference. For example, an occupant can indicate he or she is uncomfortable with a climate setting of the building space (e.g., the occupant desires an increase in general comfort by increasing or decreasing a temperature setting of the building space). As another example, an occupant can indicate he or she is uncomfortable with the lighting of the building space (e.g., the occupant desires an increase in general comfort by a change in lighting of the building space). As a further example, an occupant can indicate he or she is uncomfortable with an environment of the building space (e.g., the occupant desires an increase in general comfort by a change in fan noise of an HVAC system of the building space).

Receiving the number of occupant preferences 106 can include receiving a number of climate preferences from each occupant of a building space. As used herein, climate preferences can include temperature, relative humidity, and/or indoor air quality of the building space.

Receiving a climate preference from the number of occupants can include an explicit indication that the occupant feels the building space is too hot. For example, an occupant may feel warm in the building space and would prefer that the building space was cooler. The occupant can explicitly indicate, via their mobile device (e.g., as will be further described herein), their preference that the building space is too hot.

Similarly, receiving a climate preference from the number of occupants can include an explicit indication that an occupant feels the building space is too cold. For example, an occupant may feel cold in the building space and would prefer that the building space was warmer. The occupant can explicitly indicate, via their mobile device, their preference that the building space is too cold.

Additionally, receiving a climate preference from the number of occupants can include an explicit indication that an occupant is comfortable with the temperature of the building space. For example, an occupant may feel comfortable in the building space and would prefer that the building space remains at the same temperature. The occupant can indicate, via their mobile device, their explicit preference that the building space is a comfortable temperature.

In some embodiments, an occupant may not need to explicitly indicate he or she feels comfortable in the building space. For example, controller 102 can assume, based on an occupant not explicitly indicating a climate preference (e.g., controller 102 not receiving a climate preference), that the occupant is comfortable with the temperature and prefers the building space remains at the same temperature. That is, receiving a climate preference from the number of occupants can include an implicit indication that the occupant is comfortable with the temperature of the building space. By not indicating a climate preference via their mobile device, the occupant can implicitly indicate comfort in the space with respect to the temperature of the space.

Although climate preferences are described above as including receiving preferences that the building space is too hot, cold, or comfortable with respect to temperature, embodiments of the present disclosure are not so limited. For example, an occupant may feel the humidity level in the building space is too high, and would prefer that the humidity level in the building space was lower (e.g., drier). The occupant can explicitly indicate, via their mobile device, their climate preference that the building space is too humid. As another example, an occupant may feel the air quality level in the building space is too low, and would prefer fresh air. The occupant can explicitly indicate, via their mobile device, their climate preference with respect to the indoor air quality of the building space.

Additionally, receiving a climate preference from the number of occupants can include an explicit indication that the occupant feels the climate of the building space is at an adequate level. For example, an occupant may feel comfortable in the building space and would prefer that the building space remains at the same humidity level and/or indoor air quality level. The occupant can explicitly indicate, via their mobile device, their climate preference that the building space is at a comfortable climate level (e.g., the temperature, humidity and/or indoor air quality of the building space is comfortable).

In some embodiments, an occupant may not need to explicitly indicate he or she feels the building space is at a comfortable climate level. For example, controller 102 can assume, based on an occupant not explicitly indicating a climate preference (e.g., controller 102 not receiving a climate preference), that the occupant is comfortable with the climate level of the building space and prefers the building space remains at the same climate level. That is, receiving a climate preference from the number of occupants can include an implicit indication that the occupant is comfortable with the climate of the building space. By not indicating a climate preference via their mobile device, the occupant can implicitly indicate comfort in the space with respect to the climate of the space.

Receiving the number of occupant preferences 106 can include receiving a number of lighting preferences from each occupant of a building space. Receiving a lighting preference from the number of occupants can include an explicit indication that an occupant feels the building space is uncomfortable with the general lighting (e.g., artificial and/or natural lighting). Lighting preferences can include preferences regarding natural lighting (e.g., too much or not enough natural lighting from windows), artificial lighting (e.g., overhead lighting is too bright, too dark, etc.), and/or settings of window blinds (e.g., too much or not enough shading).

For example, an occupant may feel the lighting in the building space is too bright, too dark, and/or too much or not enough natural lighting, and would prefer that the lighting in the building space be changed (e.g., darker). The occupant can indicate, via their mobile device, their lighting preference that the building space is an uncomfortable with the lighting. As used herein, lighting can include artificial lighting and/or natural lighting.

Additionally, receiving a lighting preference from the number of occupants can include an explicit indication that the occupant feels the lighting of the building space is at a comfortable level. For example, an occupant may feel comfortable with the lighting level in the building space and would prefer that the building space remains at the same luminosity. The occupant can explicitly indicate, via their mobile device, their lighting preference that the building space is at a comfortable lighting level.

In some embodiments, an occupant may not need to explicitly indicate he or she feels the building space is at a comfortable lighting level. For example, controller 102 can assume, based on an occupant not explicitly indicating a lighting preference (e.g., controller 102 not receiving a lighting preference), that the occupant is comfortable and prefers the building space remains at the same lighting level. That is, receiving a lighting preference from the number of occupants can include an implicit indication that the occupant is comfortable with the lighting level of the building space. By not indicating a lighting preference via their mobile device, the occupant can implicitly indicate comfort in the space with respect to the lighting of the space.

Receiving the number of occupant preferences 106 can include receiving a number of environmental preferences from each occupant of a building space. Receiving an environmental preference from the number of occupants can include an explicit indication that an occupant feels the building space is at an uncomfortable environmental level. Environmental preferences can include preferences regarding fan noise associated with a blower of an HVAC system, among other climate preferences of a building space.

For example, an occupant may feel the fan noise level in the building space is too high, and would prefer that the fan noise level in the building space was lower (e.g., more quiet). The occupant can explicitly indicate, via their mobile device, their environmental preference that the fan noise in the building space is too loud.

Additionally, receiving an environmental preference from the number of occupants can include an explicit indication that the occupant feels the fan noise of the building space is at an adequate level. For example, an occupant may feel comfortable in the building space and would prefer that the building space remains at the same level of fan noise. The occupant can explicitly indicate, via their mobile device, their environmental preference that the building space is at a comfortable fan noise level.

In some embodiments, an occupant may not need to explicitly indicate he or she feels the building space is at a comfortable environmental level. For example, controller 102 can assume, based on an occupant not explicitly indicating an environmental preference (e.g., controller 102 not receiving an environmental preference), that the occupant is comfortable with the environmental level of the building space and prefers the building space remains at the same environmental level. That is, receiving an environmental preference from the number of occupants can include an implicit indication that the occupant is comfortable with the environment of the building space. By not indicating an environmental preference via their mobile device, the occupant can implicitly indicate comfort in the space with respect to the environment of the space.

The number of occupant preferences 106 can be weighted depending on who the occupant of the building space is. Occupant preferences 106 can be weighted based on a persona model 104, where each occupant of the building space can have a persona model 104 associated with the occupant's mobile device. The persona model 104 of each occupant can include identity information of the occupant, as well as past occupant preferences.

Identity information of the persona model 104 of an occupant can include a name of the occupant, an age of the occupant, physical characteristics of the occupant, the position of the occupant (e.g., the occupant's rank in the organization), as well as the location of the occupant's workspace, among other types of identity information.

The number of weighted occupant preferences 106 can be weighted according to the occupant's persona model 104. As used herein, a weighted occupant preference can refer to an occupant preference multiplied by a factor reflecting the preference's importance. For example, the preference of an occupant such as a supervisor can be considered with more weight than the preference of an occupant who holds a lower position than the supervisor. As another example, a preference of an occupant who is in a building space that includes the occupant's workspace (e.g., the occupant's cubicle, etc.) can be considered with more weight than the preference of a different occupant but who does not have a workspace in that building space (e.g., the different occupant works in a different building space).

The persona model 104 of each occupant can include past occupant preferences of each occupant. Past occupant preferences can include past climate, lighting, and/or environmental preferences. Additionally, past occupant preferences can include the location (e.g., the building space associated with the occupant preference) of each past occupant preference, the time the past occupant preference was received, the settings of the building space at the time of the receipt of the occupant preference, other internal variables (e.g., actual temperature, lighting level, and/or humidity level of the building space, etc.), and other external variables (e.g., outdoor temperature, outdoor lighting level, and/or outdoor humidity level, etc.).

The persona model 104 can be generated over time based on a comparison of past occupant preferences of each occupant to actual internal variables of the building space. Using learning models similar to learning models used for feasibility analysis (e.g., Naïve Bayes, support vector machine, logistic regression, etc., as will be further described herein), persona profiles for each occupant can be generated based on explicit and/or implicit comfort indications and an acceptable range of internal variable settings of the building space, including temperature, lighting (lighting levels of natural and/or artificial light), climate (e.g., relative humidity, air quality, air speed, fresh air exchanges, fresh air balance, etc.), among other internal variable settings of the building space.

Controller 102 can receive a number of internal variables 116 of a building space. Internal variables 116 of the building space can include an internal temperature of the building space, an internal relative humidity level of the building space, an internal air quality level of the building space, internal lighting, fan speeds, levels of CO2 in the air of the building space, levels of O2 in the air of the building space, frequency and/or magnitude of air exchanges to the building space, fresh air balance of the building space, HVAC damper positions, positions of window blinds, occupancy including the number of occupants, and/or the schedule of occupancy (e.g., from reservation systems), among other internal variables of the building space. The internal variables of the building space can include current readings, recent trends in readings, and/or historical trends in readings. Readings can include temperature, relative humidity, readings. Controller 102 can receive the number of internal variables 116 from a number of internal sensors, as will be described in connection with FIG. 2. Controller 102 can receive a number of external variables 118 of a building space. External variables 118 of the building space can include an external temperature, an external humidity level, an external lighting level, wind speed, wind direction, angle and direction of sunlight, precipitation, and/or outdoor air quality, among other external readings. The external variables of the building space can include current readings, recent trends in readings, and/or historical trends in readings, including weather forecasts, etc. Controller 102 can receive the number of external variables 118 from a number of external sensors, as will be described in connection with FIG. 2.

Controller 102 can receive settings 114. Settings 114 can include current settings associated with a building space, recent settings associated with the building space, and/or a schedule associated with temperature, relative humidity, CO2, O2, damper position, air intake, chilled water temperature, hot water temperature and/or reheater set points, among other settings and/or set points. For example, controller 102 can receive current and/or recent temperature settings (e.g., set points) of an HVAC system associated with a building space.

Controller 102 can receive energy consumption 108 of an HVAC system associated with a building and/or building space. For example, controller 102 can receive an amount of energy being used by the HVAC and/or lighting system associated with current settings 114 of the building space.

Controller 102 can determine whether each weighted occupant preference 106 is feasible by a learning model. A learning model can include classification methods such as a Naïve Bayes classification model, a support vector machine, or logistic regression, although embodiments of the present disclosure are not limited to the previously mentioned classification methods. The learning model can use the persona model 104 of each occupant of the building space, the number of internal variables 116 of the building space, the number of external variables 118 of the building space, current settings 114 for the number of internal variables of the building space, as well as setting thresholds for the number of internal variables of the building space to determine feasibility of the number of weighted occupant preferences 106.

The learning model can determine the feasibility of each weighted occupant preference 106 by a number of different classification methods, including but not limited to a Naïve Bayes classifier, a support vector machine, or by logistic regression. As used herein, a learning model can be machine learning of a task (e.g., classification of occupant preferences) by inferring a function from training data. That is, the learning model can receive example inputs (e.g., training data) in order to make data-driven predictions and/or decisions (e.g., determining feasibility), and can be supervised or unsupervised.

Initializing the learning model with example inputs can include providing training data the learning model. For example, initial temperature settings (e.g., thermostat set points), lighting level settings, and relative humidity level settings of the HVAC system and/or lighting system of the building space can be provided to the learning model. As time progresses, the learning model can receive a number of weighted occupant preferences 106, determine the feasibility of those preferences, and modify settings (e.g., modified settings 110) of the HVAC system and/or lighting system of the building space accordingly, as will be further described herein. Further, the learning model can utilize occupant feedback about the modified settings 110 to further modify settings as necessary, as will be further described herein.

In some embodiments, the learning model can determine feasibility of each occupant preference by a Naïve Bayes classifier. The Naïve Bayes classifier can assign class labels (e.g., feasible or infeasible) to problem instances. For example, the Naïve Bayes classifier can utilize the persona model 104 of each occupant of the building space, the number of weighted occupant preferences 106, the number of internal variables 116 of the building space, the number of external variables 118 of the building space, current settings 114 for the number of internal variables of the building space, as well as setting thresholds for the number of internal variables 116 of the building space as vectors. The vectors can be used to assign probabilities to each of two possible classes (e.g., feasible or infeasible).

In some embodiments, the learning model can determine feasibility of each occupant preference by a support vector machine. A support vector machine can utilize training examples to assign new data into one category or another category (e.g., a non-probabilistic binary linear classifier). That is, the support vector machine can utilize training data (e.g., initial temperature settings, lighting level settings, and relative humidity level settings of the HVAC system and/or lighting system) to classify weighted occupant preferences 106 as either feasible or infeasible utilizing the persona model 104 of each occupant of the building space, the number of internal variables 116 of the building space, the number of external variables 118 of the building space, current settings 114 for the number of internal variables of the building space, as well as setting thresholds for the number of internal variables of the building space

In some embodiments, the learning model can determine feasibility of each occupant preference by logistic regression. Logistic regression can utilize the number of weighted occupant preferences 106, as well as the relationship between the number of weighted occupant preferences 106 and the persona model 104 of each occupant of the building space, the number of internal variables 116 of the building space, the number of external variables 118 of the building space, current settings 114 for the number of internal variables of the building space, as well as setting thresholds for the number of internal variables of the building space as discrete response variables to classify the number of weighted occupant preferences 106 as feasible or infeasible.

Although the learning model is described as a Naïve Bayes, support vector machine, or logistic regression, embodiments of the present disclosure are not so limited. For example, the classification model can be any other model or classification method that can receive example inputs and make data-driven predictions and/or decisions.

The learning model can further utilize a frequency of the received number of weighted occupant preferences and a recency of the received number of weighted occupant preferences to determine the feasibility of the number of weighted occupant preferences 106. For example, if an occupant is very frequently indicating preferences that the temperature is too hot, controller 102 can determine the preference is infeasible due to the occupant attempting to unduly influence the temperature setting (e.g., temperature set point) of the building space. As an additional example, the controller 102 can analyze how recently the occupant has indicated a preference in determining feasibility. That is, if the user has indicated a climate preference in the very recent past, controller 102 can use that information in determining whether the user is trying to unduly influence the temperature setting, and can determine feasibility of the preference accordingly. As a further example, controller 102 can use trends in actual conditions to determine if the HVAC system will reach a desired temperature setting or is going past a setting threshold.

The learning model can further utilize building setting thresholds for the number of internal variables 116 of the building space. As used herein, building setting thresholds can be threshold set points of the HVAC system and/or lighting system of the building space. For example, a building set point threshold for temperature may be 67 degrees Fahrenheit, below which the HVAC system cannot allow the actual temperature of the building space to drop. That is, controller 102 can determine, based on an actual internal temperature of 67 degrees, that an occupant preference that the building space is too hot is infeasible, since the HVAC system cannot cool the building space past 67 degrees.

Occupants in the building space can give feedback after controller 102 has generated modified settings 110. For example, the number of occupants can indicate, via a number of mobile devices, whether they are satisfied or not with the modified settings 110. The learning model can then incorporate occupant feedback when determining feasibility of the number of weighted occupant preferences 106.

Infeasible occupant preferences can be used for diagnostics 112. For example, if occupants in the building space indicate that they are feeling very cold, but that external variables 118 indicate that the outdoor air temperature is very hot, the controller 102 can determine that the preferences of the occupants are infeasible and that there may be a problem with the HVAC system (e.g., it is cooling the building space too much). The infeasible preferences used for diagnostics 112 can alert a building supervisor and/or building management to a potential problem with the HVAC system of the building.

Controller 102 can modify a setting for the number of internal variables 116 of the building based on whether the number of feasible occupant preferences is greater than a threshold number. For example, controller 102 can receive the number of weighted occupant preferences 106 in a defined time period and/or after an event. For example, the time period can be one hour, although embodiments of the present disclosure are not so limited. That is, the controller can receive the number of weighted occupant preferences 106 over the defined time period (e.g., one hour), and if enough preferences are feasible, controller 102 can modify a setting for the number of internal variables 116 of the building (e.g., modify a temperature set point) at the end of the time period or after the event. As used herein, an event can include a scheduled event. For example, a building space such as a ballroom may host a scheduled meeting; controller 102 can modify a setting for the number of internal variables 116 of the ballroom after the scheduled meeting has taken place.

Controller 102 can determine a recover period of the number of internal variables after modifying a setting for the number of internal variables. As used herein, a recovery period can refer to an amount of time a modification of a setting for an internal variable of the building space takes to take effect. For example, a modification to a temperature setting may take 15 minutes to take effect; the recovery period of the temperature modification can therefore be 15 minutes.

Controller 102 can que weighted occupant preferences received during the recovery period until the recovery period is passed. For example, the recovery period of a temperature change can be 15 minutes. Weighted occupant preferences for a temperature of the building space received during the 15 minute recovery period can be queued until the 15 minute recovery period is passed (e.g., expired).

Different internal variables of the number of internal variables can have different recovery periods. For example, a recovery period of a modification in a temperature setting of a building space can take longer than a recovery period of a change in a lighting setting of the building space. Additionally, different building spaces can have different recovery periods for the same or similar internal variables. For example, a recovery period of a modification of a temperature setting of a large room (e.g., an auditorium) can be longer than a recovery period of a modification of a temperature setting of a smaller room (e.g., an office).

The modified settings 110 can be determined for a future time period. For example, the modified settings 110 can be set for a new one hour time period, where the controller can again receive a number of weighted occupant preferences 106, a persona model 104 of each occupant, current settings 114 of the building space, a number of internal variables 116 of the building space, a number of external variables 118 of the building space, and energy consumption 108 of an HVAC system and/or lighting system associated with the building space to determined modified settings 110 based on the feasibility of the number of weighted occupant preferences 106 for another future time period.

Controller 102 can change the length of the time period. For example, controller 102 can change the length of the time period for receipt of the number of weighted occupant preferences 106, the persona model 104 of each occupant, current settings 114 of the building space, the number of internal variables 116 of the building space, the number of external variables 118 of the building space, and energy consumption 108 of an HVAC system and/or lighting system associated with the building space from one hour to thirty minutes (e.g., a future time period). That is, the future time period is the length of the changed time period. As another example, the controller 102 can change the time period to one hour and thirty minutes. As a further example, the controller 102 can change the time period to any other suitable length of time.

Determining crowd comfortable settings using occupant preferences can allow for the incorporation of all users' comfort preferences in determining settings of a building space. Determining settings by occupant preferences can maximize the number of occupants that are satisfied with settings of the building space. In addition, the energy consumption 108 of the HVAC system and/or lighting system of the building space can be minimized.

FIG. 2 illustrates a system for crowd comfortable settings, in accordance with one or more embodiments of the present disclosure. System 220 can include a building space 222 and external sensors 226-1, 226-2, and 226-N. Building space 222 can include controller 202, internal sensors 224-1, 224-2, 224-3, and 224-N, and mobile devices 228-1, 228-2, and 228-N.

As shown in FIG. 2, the system 220 for crowd comfortable settings can include a number of mobile devices 228-1, 228-2, and 228-N, and a controller 202 (e.g., controller 102, previously described in connection with FIG. 1) to receive from the number of mobile devices 228-1, 228-2, and 228-N a number weighted occupant preferences (e.g., weighted occupant preferences 106, previously described in connection with FIG. 1) for a specified time period. The number of weighted occupant preferences can be received from the number of mobile devices 228-1, 228-2, and 228-N corresponding to each occupant of building space 222 via a wired or wireless network.

The wired or wireless network can be a network relationship that connects the number of mobile devices 228-1, 228-2, and 228-N to controller 202. Examples of such a network relationship can include a local area network (LAN), wide area network (WAN), personal area network (PAN), a distributed computing environment (e.g., a cloud computing environment), Bluetooth, a mobile hotspot, and/or the Internet, among other types of network relationships.

As used herein, a mobile device can include a device that is (or can be) carried and/or worn by an occupant of the building space. The number of mobile devices 228-1, 228-2, and 228-N can be a phone (e.g., a smart phone), a tablet, a personal digital assistant (PDA), smart glasses, and/or a wrist-worn device (e.g., a smart watch), among other types of mobile devices and/or wearable devices.

For example, building space can have N occupants, each with a mobile device 228-N. Each of the N occupants of building space 222 can indicate, explicitly or implicitly, a preference about the climate, lighting, and/or environment of building space 222.

Although described as receiving a preference from a mobile device, embodiments of the present disclosure are not so limited. For example, occupants of a building space can indicate a preference by a desktop computer, laptop computer, and/or RFID tag, among other types of devices.

Controller 202 can receive, from the number of internal sensors 224-1, 224-2, 224-3, and 224-N, of building space 222, a number of internal variables (e.g., number of internal variables 116, previously described in connection with FIG. 1) of building space 222. The number of internal variables of building space 222 can include an internal temperature of building space 222, an internal humidity level of building space 222, an internal air quality level of building space 222, and/or an internal lighting level of building space 222. The number of internal variables of building space 222 can be transmitted to controller 202 via a network relationship. For example, the number of internal variables of building space 222 can be transmitted to controller 202 via a wired or wireless network.

The wired or wireless network can be a network relationship that connects the number of internal sensors 224-1, 224-2, 224-3, and 224-N to controller 202. Examples of such a network relationship can include a local area network (LAN), wide area network (WAN), personal area network (PAN), a distributed computing environment (e.g., a cloud computing environment), and/or the Internet, among other types of network relationships.

In some embodiments, the number of internal sensors 224-1, 224-2, 224-3, and 224-N can include a temperature sensor to determine an internal temperature of building space 222. For example, the number of internal sensors 224-1, 224-2, 224-3, and 224-N can include a thermometer (e.g., resistance thermometer), thermocouple, thermistor, silicon bandgap temperature sensor, and/or any other suitable temperature sensor, although embodiments of the present disclosure are not limited to the above listed temperature sensors.

In some embodiments, the number of internal sensors 224-1, 224-2, 224-3, and 224-N can include a humidity sensor to determine an internal humidity level of building space 222. For example, the number of internal sensors 224-1, 224-2, 224-3, and 224-N can include a humistor, humidistat, and/or any other suitable humidity sensor, although embodiments of the present disclosure are not limited to the above listed humidity sensors.

In some embodiments, the number of internal sensors 224-1, 224-2, 224-3, and 224-N can include an air quality sensor to determine an internal air quality of building space 222. For example, the number of internal sensors 224-1, 224-2, 224-3, and 224-N can include an air quality sensor to detect indoor air quality of building space 222, including particle concentration of particulate matter, and/or specific types of gases (e.g., harmful gases) such as carbon monoxide, carbon dioxide, alcohol, acetone, formaldehyde, etc. The air quality sensor can vary by the building space type. For example, a laboratory can have a different type of air quality sensor than an office space, as a laboratory can have air quality standards that can be different than an office space.

In some embodiments, the number of internal sensors 224-1, 224-2, 224-3, and 224-N can include a lighting sensor to determine an internal lighting of building space 222. For example, the number of internal sensors 224-1, 224-2, 224-3, and 224-N can include a photoresistor, photodiode, and/or any other suitable lighting sensor, although embodiments of the present disclosure are not so limited to the above listed lighting sensors.

In some embodiments, the number of internal sensors 224-1, 224-2, 224-3, and 224-N can include sensors to determine occupancy of the building space. For example, the number of internal sensors 224-1, 224-2, 224-3, and 224-N can include thermal cameras, occupancy sensors, and/or any other suitable occupancy sensor, although embodiments of the present disclosure are not so limited to the above listed occupancy sensors.

Controller 202 can receive, from the number of external sensors 226-1, 226-2, and 226-N, a number of external variables (e.g., number of external variables 118, previously described in connection with FIG. 1) of building space 222. The number of external variables of building space 222 can include an external temperature (e.g., outdoor temperature) of building space 222, an external humidity level (e.g., outdoor humidity) of building space 222, and/or an external lighting level (e.g., outdoor lighting) of building space 222. The number of external variables of building space 222 can be transmitted to controller 202 via a network relationship. For example, the number of external variables of building space 222 can be transmitted to controller 202 via a wired or wireless network.

The wired or wireless network can be a network relationship that connects the number of external sensors 226-1, 226-2, and 226-N to controller 202. Examples of such a network relationship can include a local area network (LAN), wide area network (WAN), personal area network (PAN), a distributed computing environment (e.g., a cloud computing environment), and/or the Internet, among other types of network relationships.

Similar to the number of internal sensors 224-1, 224-2, 224-3, and 224-N of building space 222, the number of external sensors 226-1, 226-2, and 226-N can include a thermometer (e.g., resistance thermometer), thermocouple, thermistor, silicon bandgap temperature sensor, and/or any other suitable temperature sensor, a humistor, humidistat, and/or any other suitable humidity sensor, and a photoresistor, photodiode, and/or any other suitable lighting sensor.

In some embodiments, controller 202 can receive the number of external variables of building space 222 by external means. For example, the number of external variables can be downloaded over the Internet or another wired or wireless connection.

Controller 202 can receive a persona model of each occupant, a number of weighted occupant preferences, energy consumption of an HVAC system and/or lighting system of building space 222, current settings, internal variables from a number of internal sensors 224-1, 224-2, 224-3, and 224-N, and external variables from a number of external sensors 226-1, 226-2, and 226-N, determine the feasibility of the number of weighted occupant preferences by a learning model (e.g., previously described in connection with FIG. 1), and modify a number of settings of the internal variables of building space 222 based on whether the number of feasible occupant preferences is greater than a threshold number.

In some embodiments, although not shown in FIG. 2, a building can include a number of building spaces. The number of building spaces can include different areas of a building. For example, the number of building spaces can include open office areas, individual office spaces, conference rooms, large open spaces (e.g., an auditorium, ballroom, warehouse, manufacturing space, production facility, etc.), hotel rooms, meeting rooms, ship cabins, etc.

Each of the number of building spaces can include different settings for the number of internal variables. For example, an open office area can include occupants indicating comfort preferences that correspond to a setting for the open office area. As another example, a conference room can include occupants indicating comfort preferences that can correspond to a setting for the conference room that may be different than the open office area.

The time period for receiving a number of weighted occupant preferences can vary by space type. For example, the time period for a conference room can be longer (e.g., 1 hour) than a large open space (e.g., 30 minutes) such as an auditorium, since the large open space can have a higher instance of transient traffic and would need to change settings more quickly to satisfy the occupants of the large open space. In some embodiments, the number of mobile devices 228-1, 228-2, and 228-N can automatically indicate a comfort preference to a controller based on the location of the mobile device. For example, the mobile device of an occupant of an individual office space can indicate to a controller of the individual office space the occupant is comfortable with the temperature of the individual office space by the occupant's past occupant preferences included in the persona model of the occupant. The mobile device of the occupant can send a further indication of comfort as the occupant moves to a different building space, as long as the temperature of the different building space is the same or only slightly different.

Crowd comfortable settings using the number of mobile devices 228-1, 228-2, and 228-N in building space 222 can allow for sustainable occupant comfort while managing and incorporating the preferences of the number of occupants' for building space 222. Further, as occupants of a building move between spaces, comfort can be maintained while managing the preferences of occupants and maintaining energy savings.

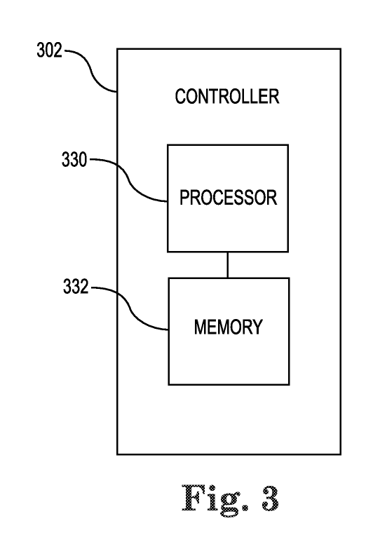

FIG. 3 is a schematic block diagram of a controller for crowd comfortable settings, in accordance with one or more embodiments of the present disclosure. Controller 302 can be, for example, controller 102 and 202, previously described in connection with FIGS. 1 and 2, respectively. Controller 302 can include a memory 332 and a processor 330 configured for crowd comfortable settings, in accordance with the present disclosure.

The memory 332 can be any type of storage medium that can be accessed by the processor 330 to perform various examples of the present disclosure. For example, the memory 332 can be a non-transitory computer readable medium having computer readable instructions (e.g., computer program instructions) stored thereon that are executable by the processor 330 to receive a number of weighted occupant preferences of a building space and receive a number of internal variables of the building space and a number of external variables of the building space. Further, processor 330 can execute the executable instructions stored in memory 332 to determine whether each weighted occupant preference is feasible by a learning model, and modify a setting for the number of internal variables of the building space based on whether the number of feasible occupant preferences is greater than a threshold number.

The memory 332 can be volatile or nonvolatile memory. The memory 332 can also be removable (e.g., portable) memory, or non-removable (e.g., internal) memory. For example, the memory 332 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 332 is illustrated as being located within controller 302, embodiments of the present disclosure are not so limited. For example, memory 332 can also be located internal to another computing resource (e.g., enabling computer readable instructions to be downloaded over the Internet or another wired or wireless connection).

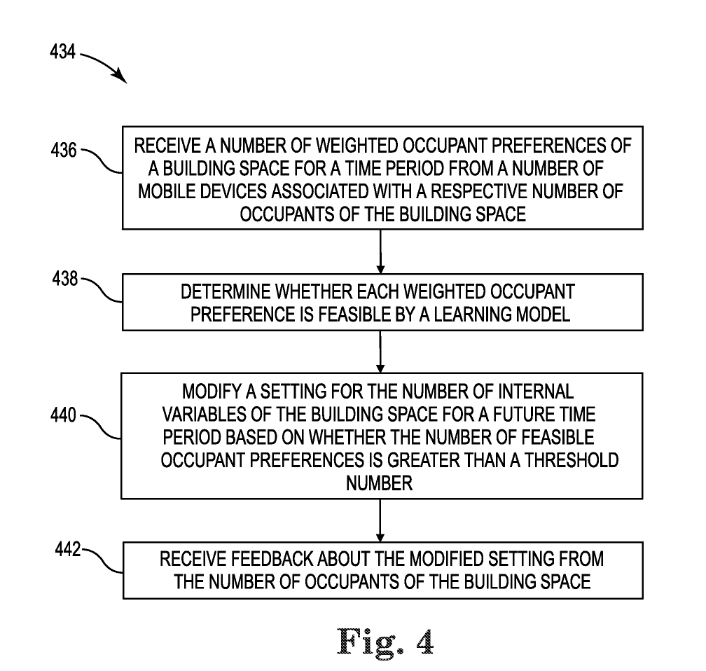

FIG. 4 is a flow chart of a method for crowd comfortable settings, in accordance with one or more embodiments of the present disclosure. Method 434 can be performed by, for example, controllers 102, 202, and 302 described in connection with FIGS. 1, 2, and 3, respectively.

At 436, the method 434 can include receiving a number of weighted occupant preferences of a building space for a time period from a number of mobile devices associated with a respective number of occupants of the building space. For instance, a number of occupants of the building space can indicate, via their respective mobile devices, their preference for a number of settings of a building space for a time period. For example, the number of occupants can indicate whether they are too hot, cold, or comfortable with the temperature of the building space.

At 438, the method 434 can include determining whether each weighted occupant preference is feasible by a learning model. The learning model can use a persona model of each occupant of the building space, as well as a number of internal variables of the building space (e.g., temperature, lighting, humidity), a number of external variables of the building space (e.g., outdoor temperature, outdoor lighting, outdoor humidity), current settings for the number of internal variables of the building space, as well as setting thresholds for the number of internal variables of the building space to determine the feasibility of the weighted occupant preferences using a learning model such as a Naïve Bayes classifier, a support vector machine, or by logistic regression.

At 440, the method 434 can include modifying a setting for the number of internal variables of the building space for a future time period based on whether the number of feasible occupant preferences is greater than a threshold number. For example, if the learning model determines a number of occupant preferences is greater than a threshold number during a current time period, the controller can modify a setting (e.g., a temperature set point) of the internal variables of the building space. Modifying a setting for the number of internal variables of the building space can include modifying a temperature set point, modifying window blinds, modifying lighting settings, fresh air exchanges, and/or other internal variables, as previously described in connection with FIG. 1.

Modifying the setting of the number of internal variables of the building space can include modifying the setting based on past occupant preferences. Past occupant preferences can be included in a persona model received by the controller.

Modifying the setting of the number of internal variables of the building space can include modifying the setting based on received location information associated with each mobile device of each occupant. For example, an occupant preference may only be considered if the occupant's mobile device is located in the space the occupant is indicating a comfort preference for.

At 442, the method 434 can receiving feedback about the modified setting from the number of occupants of the building space. For example, occupants can give feedback about the modified setting (e.g., whether the occupants are satisfied with the modified setting), that can be utilized when determining whether to further modify a setting of the building space.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor. It is presumed that logic similarly executes instructions for purposes of the embodiments of the present disclosure.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A controller for determining crowd comfortable settings, comprising:
a memory;
a processor configured to execute executable instructions stored in the memory to:
receive a number of weighted occupant preferences of a building space;
receive a number of internal variables of the building space and a number of external variables of the building space;
determine whether each weighted occupant preference is feasible using a persona model of each occupant of the building space, the number of occupant preferences, the number of internal variables of the building space, the number of external variables of the building space, building space settings for the number of internal variables of the building space, and setting thresholds for the number of internal variables of the building space; and
modify a setting for the number of internal variables of the building space based on whether the number of feasible occupant preferences is greater than a threshold number.

2. The controller of claim 1, wherein the feasibility of each occupant preference by a learning model.

3. The controller of claim 1, wherein the weighted occupant preferences are based on the persona model of each occupant, and wherein the persona model of each occupant includes:
identity information; and
past occupant preferences.

4. The controller of claim 1, wherein the number of weighted occupant preferences include at least one of a climate preference, a lighting preference, and an environmental preference.

5. The controller of claim 1, wherein the number of internal variables of the building space include:
an internal temperature of the building space;
an internal humidity level of the building space;
an internal air quality level of the building space; and
an internal lighting level of the building space.

6. The controller of claim 1, wherein the number of external variables of the building space include:
an external temperature;
an external humidity level; and
an external lighting level.

7. The controller of claim 1, wherein the number of weighted occupant preferences are received from a number of mobile devices corresponding to each occupant of the building space.

8. The controller of claim 1, wherein infeasible occupant preferences are used for diagnostics.

9. A computer implemented method for determining crowd comfortable settings, comprising:
receiving, by a controller, a number of weighted occupant preferences of a building space for a time period from a number of mobile devices associated with a respective number of occupants of the building space;
receiving, by the controller, a number of internal variables of the building space and a number of external variables of the building space for the time period;
determine, by the controller, whether each weighted occupant preference is feasible by a learning model using:
a persona model of each occupant of the building space;
the number of occupant preferences of the building space received in the time period;
the number of internal variables of the building space received in the time period;
the number of external variables of the building space received in the time period;
building space settings for the number of internal variables of the building space for the time period; and
setting thresholds for the number of internal variables of the building space;
modifying, by the controller, a setting for the number of internal variables of the building space for a future time period based on whether the number of feasible occupant references is greater than a threshold number; and
receiving, by the controller, feedback about the modified setting from the number of occupants of the building space.

10. The method of claim 9, wherein receiving the number of weighted occupant preferences includes receiving a climate preference, wherein the climate preference indicates:
the building space is at an uncomfortable climate level; or
the building space is at a comfortable climate level.

11. The method of claim 9, wherein receiving the number of weighted occupant preferences includes receiving a lighting preference, wherein the lighting preference indicates:
the building space is at an uncomfortable lighting level; or
the building space is at a comfortable lighting level.

12. The method of claim 9, wherein receiving the number of weighted occupant preferences includes receiving an environmental preference, wherein the environmental preference indicates:
the building space is at an uncomfortable environmental level; or
the building space is at a comfortable environmental level.

13. The method of claim 9, wherein receiving the number of weighted occupant preferences further includes receiving past occupant preferences based on the persona model.

14. The method of claim 13, wherein modifying the setting for the number of internal variables includes modifying the setting based on the past occupant preferences and the feedback from the number of occupants.

15. The method of claim 9, wherein modifying the setting for the number of internal variables includes modifying the setting based on received location information associated with each mobile device of each occupant.

16. The method of claim 9, wherein determining the feasibility of the number of occupant preferences is further based on:
a frequency of the received number of occupant preferences;
a recency of the received number of occupant preferences; and
energy consumption of a heating, ventilation, and air-conditioning system of a building comprising the building space.

17. The method of claim 9, wherein the method further includes:
determining a recovery period of the number of internal variables after modifying a setting for the number of internal variables; and
queuing weighted occupant preferences received during the recovery period until the recovery period is passed.

18. A system for determining crowd comfortable settings, comprising:
a number of mobile devices of a respective number of occupants; and
a controller, configured to:
receive, from the number of mobile devices of the number of occupants, a number of weighted occupant preferences of a number of building spaces of a building for a time period;
receive, from a number of internal sensors, a number of internal variables of the number of building spaces for the time period;
receive, from a number of external sensors, a number of external variables of the building for the time period;
determine whether each weighted occupant preference is feasible by a learning model using the number of occupant preferences, the number of internal variables of the number of building spaces, and the number of external variables of the building; and
modify a number of settings for the number of internal variables of the number of building spaces for a future time period based on whether the number of feasible occupant preferences is greater than a threshold number.

19. The system of claim 18, wherein each of the number of building spaces include different settings for the number of internal variables.

20. The system of claim 18, wherein the controller is further configured to change a length of the time period.
